(19) United States
(12) Patent Application Publication
(10) Pub. No.: US 2020/0121560 A1
(43) Pub. Date: Apr. 23, 2020

(54) PILL DISPENSING ASSEMBLY AND METHOD OF USE

(71) Applicant: LEVI DALTON THOMAS, COATS, NC (US)

(72) Inventor: LEVI DALTON THOMAS, COATS, NC (US)

(21) Appl. No.: 16/655,862

(22) Filed: Oct. 17, 2019

Related U.S. Application Data
(60) Provisional application No. 62/766,425, filed on Oct. 17, 2018.

(51) Int. Cl. A61J 7/00; B65D 83/04; A61J 7/04

(52) U.S. Cl. CPC A61J 7/0076; B65D 83/0454; A61J 2200/30; A61J 7/0436; A61J 7/0409

(57) ABSTRACT

A pill dispensing assembly is provided herein for safe and tamper proof dispensing of solid, oral medications (e.g., pills) and tracking the use of the same. Methods of using the pill dispensing assembly are also provided herein. The pill dispensing assembly can contain as few as two mechanical components in conjunction with accessory parts. For example, the pill dispensing assembly can contain an indexing cover layer and a container layer. The indexing cover layer can contain an exit port and an index lock and the container layer can contain elements that hold pills for storing and dispensing such as pockets as well as an index slot array that interacts with index lock. The pill dispensing assembly is designed to dispense a single pill at a time through a mechanically actuated indexing movement of indexing cover layer in relation to container layer. Structural elements involved in the indexing movement are concealed and inaccessible to the user to control tampering.

### CROSS REFERENCE TO RELATED APPLICATIONS

This application claims priority to U.S. Provisional Patent Application Ser. No. 62/766,425 filed Oct. 17, 2018. The disclosure of Application Ser. No. 62/766,425 is incorporated by reference herein in its entirety.

### TECHNICAL FIELD

The present invention relates to medication dispensing and particularly relates to a pill dispensing assembly and method for dispensing solid oral medicaments and tracking their use.

### BACKGROUND

Prescription drug abuse, particularly for opioid based medications has become an increasingly severe and far reaching societal epidemic with a long and unmet need of a solution that will significantly increase adherence to prescription scheduling and reduce diversion from the same. Addiction to prescription opioid medication is frequently a result of improper prescribing or inappropriate adherence to dosing schedules. The active ingredients in opioid based medications are highly addictive and the onset of addiction can be rapid. Under ideal circumstances, doctors should proactively address a suspected addiction with an immediate, but incremental, reduction of dosing over time. Yet in most cases, proactive measures are not taken, and the addictive pattern continues and escalates.

Various solutions based on prescribing data strive to monitor opioids at the prescription level using databases but fail to substantially address the epidemic as evident in government data. Unfortunately, data at the prescription level does not provide information indicating that the user took the medication as prescribed nor does it detect diversion. What is needed is a solution that will target elements that will prevent creation of new addicts and detect and stop prescription diversion, thus targeting the point where abuse originates.

Conventional pill dispenser designs have failed to positively impact the opioid epidemic for reasons including, but not limited to cost, number and complexity of components, unreliability, user unfriendliness, inoperability, unsuitability for filling prescriptions in a pharmacy environment, and/or incapable of accommodating varying pill sizes or dimensions. No effective solution to the opioid epidemic to detect patterns of pre-addictive dosing or detect actual diversion at the point of diversion has been deployed; therefore, there is a long and unmet need which the design in the invention described herein will address because it delivers utility that other prior art has failed to deliver.

What is needed is a low-cost pill dispensing assembly that is sufficiently small for ease of use (e.g., fits in the palm of user's hand), constructed of a limited number of injection molded mechanical parts and low-cost micro-electronics (e.g., microprocessor, memory, sensor, transponder, power source) and integrated with associated application/database (e.g. PC/cell phone based). Also needed is an apparatus that targets the point where addiction originates and diversion occurs by providing a simple, pocket sized, low cost solution with minimal structural components that monitors and makes available real time patient dosing data that can be used to deter diversion and detect/avoid non-desired dosing practices, that is disposable or reusable, that allows pharmacies to fill the apparatus with loose prescribed pills, that allows the user to dispense one pill at a time, that collects dose timing information for each pill dispensed, that accommodates most if not all pill sizes and shapes, and that provides data necessary to inform and address the unmet needs of the opioid epidemic.

### SUMMARY

A pill dispensing assembly is provided herein comprising an indexing cover layer and a container layer. In some embodiments, the pill dispensing assembly can be composed of as few as two mechanical components in conjunction with accessory parts, such as a controller/sensor described more fully below. In one embodiment, indexing cover layer can comprise an exit port, an indexing lock, a gripping member (e.g., dial), and/or one or more sensors/controllers. The pill dispensing assembly differs from a standard medicine bottle in certain key aspects, for example, it does not contain a single reservoir for holding pills; rather, each pill (or multiple pills) is held in a respective pill pocket within the container layer, which can be configured to accommodate variable pill sizes and shapes without the need for interchanging parts or constructing a different pill dispensing assembly with different pocket sizes.

In some embodiments, the container layer can comprise a rotating point element or spin bump to promote rotation of the assembly during loading operation on a flat surface, such as a counter. In one embodiment, the rotating point element is positioned on the exterior facing surface of container layer. Container layer can also comprise one or more balancing elements or protrusions on the exterior facing surface to control the degree of device tilt applied during loading operation.

In another embodiment, pill dispensing assembly can comprise a seal element. In some embodiments, the seal element is a bottom or inner facing integral surface of the indexing cover layer and made of a material that prevents ingress of moisture into the assembly thus protecting the pills. In one embodiment, the seal element is glued to the inner facing surface of the indexing cover layer. In another embodiments, the seal element is a separate ring-shaped layer or structure which comprises a central opening, an exit whole which aligns with the exit port and a seal keyway. The seal element can be positioned between or sandwiched between indexing cover layer and container layer.

In one embodiment, the pill assembly can comprise interchangeable pill trays with a plurality of pill pockets circumferentially and equally spaced apart about the perimeter of the pill tray which, in some embodiments, can be conveniently loaded with pills. The pill trays can be conveniently removed from the container layer and loaded with pills by a pharmacist while onsite at the pharmacy. The pill trays can further be configured to receive and store for dispensing a range of various pills sizes/shapes. In some embodiments, the pill tray can contain a null position with no pocket which is the starting position upon assembly of the device. The pill tray may be adapted to engage a block element which blocks one or more of the pill pockets to control pill quantity during loading operation. Block element may comprise structures that modify the size of the pockets in the pill tray and thereby pills to be loaded. Pill tray, in some embodiments, is engaged (in a rotationally fixed manner) to container layer—resting on the radial ridge array and index slot array discussed below. Alternatively, the pill tray can be an integral component of the container layer forming a single mechanical part thereof.

In yet another embodiment, the container layer comprises an index slot array. In some embodiments, the index slot array comprises a vertical side wall with a series of circumferentially and equally spaced slots which receive in locking engagement one or more indexing locks. In some embodiments, the indexing lock is positioned on the exterior side wall of the indexing cover layer. In one embodiment, the pill dispensing assembly comprises a compression wall, which in some embodiments, contains flexible sidewalls and houses the container layer. In some embodiments, the compression wall can be compressed by the user to contact and disengage the indexing lock from the slots in the container layer. In one embodiment, disengagement of the slot from indexing lock via compression of the compression wall permits indexing of the device to the next pill position. In some embodiments, the indexing cover layer is rotatable with respect to the container layer.

In some embodiments, the container layer can comprise a radial ridge array which can comprise a series of ribs radially positioned on the lower (alternatively “inner”) surface the container layer. In another embodiment, the container layer comprises a ramp feature on the inner surface of container layer that promotes biased movement of pills into proper position. In yet another embodiment, container layer can include one or more deflector elements which can be undulating surfaces in the outer vertical wall of index slot array, which act to deflect pills into the pockets of pill tray. Container layer can further comprise a detectable element array which is sensed by the one or more sensors described above. In yet another embodiment, container layer can comprise an anti-tampering barrier to help prevent undesirable sensor manipulation.

In some embodiments, container layer can comprise a compression wall which is an outermost wall of container layer with minimal clearance between the it and the outer wall of index slot array. Compression wall can be manufactured of flexible materials to allow compression of side walls adjacent to the indexing lock position determined, in some embodiments, by marking on the indexing cover layer or other suitable marking. Compression of compression wall engages and depresses indexing lock thus promoting clearance of indexing lock from slot and rotation of indexing cover layer via gripping member, for example. Alternatively, compression wall is omitted and a user compresses or depresses indexing lock directly with fingertip. To assist with loading, the assembly can comprise a loading funnel that, in some embodiments, is designed to be securely placed upon container layer. The loading funnel helps facilitate accurate loading of the pills into the container layer. In other embodiments, the assembly can contain a indexing lock, a controller/sensor for managing pill dispense information, an integrated seal surface to prevent moisture ingress and dial. In some embodiments, the indexing lock, controller/sensor, and integrated seal surface are features of the indexing cover layer.

In some embodiments, the pill dispensing assembly can comprise a pocket cover, which can comprise a thin segment of material that may be placed on top of a section of the container layer and/or pill tray to cover a desired number of pill pockets. The container layer can also include one or more anti-tampering barriers to disrupt the single plane of access via the exit port between the container layer and indexing cover layer in route to the sensor(s). Container layer can furthermore contain a post element which, in some embodiments, is located at or near and protruding up from the center of detectable element array on container layer though an opening in pill tray and through bottom surface of the indexing cover layer through aperture. Other structural features may be included to ensure post element is secured to indexing cover layer while preserving rotatability of indexing cover layer in relation to container layer.

In operation and, in some embodiments, a user must simultaneously manipulate an indexing lock and dial to rotate the device and dispense the pill. In some embodiments, rotation of the dial is in one direction and only one pill at a time can be dispensed. In one embodiment, each time the device is rotated to allow the next tablet to be dispensed, an internal sensor(s), which is connected to an internal micro-controller, detects the rotation and stores the timestamp, thus forming a log of dose times. In some embodiments, this log can be viewed by a device display and/or wirelessly uploaded to external computer system (e.g. pharmacy PC, database, cell phone) for display in human readable form (e.g. historical graph/trend). In some embodiments, the assembly can accumulate and process the dose level data (across multiple refills) and configured to make automated decisions based on that data, for example, setting limits to trigger appropriate actions and communications aimed at better pain management and prevention of addiction/diversion. Other uses for monitoring dose compliance and patient aid/reminder is also envisioned for this device (e.g. clinical trials monitoring).

### BRIEF DESCRIPTION OF THE DRAWINGS

FIG. 1 illustrates a fully assembled pill dispensing assembly.

FIG. 2A-2B illustrates exploded top angled and bottom angled views of the exemplary pill dispensing assembly.

FIG. 3A-3B illustrates an optional load funnel.

FIG. 4A-4B illustrates a close-up cut away view of indexing lock, index slot array, and compression wall.

FIG. 5A-5B illustrates a top down perspective of a container layer containing an exemplary pill tray and a cross sectional perspective of a container layer containing an exemplary pill tray.

FIG. 6 illustrates a close-up top down perspective of two pockets in a pill tray and two sections of the radial ridge array in the container layer.

FIG. 7 illustrates an exemplary post element attached to container layer.

### DETAILED DESCRIPTION

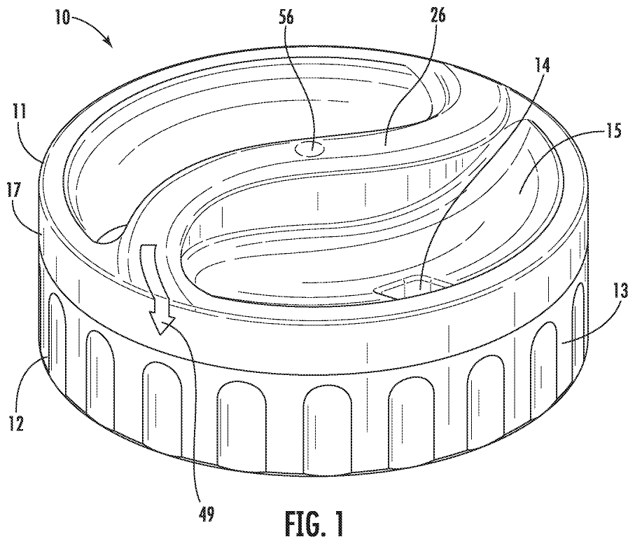

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “right,” “rear,” “front.” “vertical,” “horizontal,” “top,” “bottom,” “outer,” “inner” and derivatives thereof shall relate to the invention as oriented in FIGS. 1-7 and in no way intended to be limited to any particular orientation. Moreover, structural components can change positions, for example, an exit port on the indexing cover layer, may be switched to another layer or component. Also, the layers themselves may be reversed in orientation. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

It should be noted that although the discussions herein can refer to a specific order and composition of method steps, it is understood that the order of these steps can differ from what is described. For example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative embodiments. Accordingly, all such modifications are intended to be included within the scope of the present invention. Such variations will depend on designer choice and it is understood that all such variations are within the scope of the invention.

At the outset, it should be clearly understood that like reference numerals are intended to identify the same structural elements, portions, or surfaces consistently throughout the several drawing figures, as can be further described or explained by the entire written specification of which this detailed description is an integral part. The drawings are intended to be read together with the specification and are to be construed as a portion of the entire “written description” of this invention as required by 35 U.S.C. § 112.

Referring now to embodiments shown in FIGS. 1-7, a pill dispensing apparatus and system for controlling and/or monitoring the dispensing of pills from a container and associated application/computer interfaces is disclosed. “Pill” can include any pharmaceutical solid dose, such as a pill, tablet, gelatin capsule, or the like. The apparatus can accommodate other medicinal forms as well, such as granules and solid plant products.

FIG. 1 shows an assembled view of the pill dispensing assembly 10. In one embodiment, pill dispensing assembly 10 comprises an indexing cover layer 11, a container layer 12, and a compression wall 13. FIG. 1 also shows an exit port 14 which, in this embodiment, is shown on the exterior facing surface 15 of indexing cover layer 11. The exit port 14 is an outlet to the exterior environment for pills as they are dispensed. Once a pill passes through exit port 14, it becomes accessible to the user.

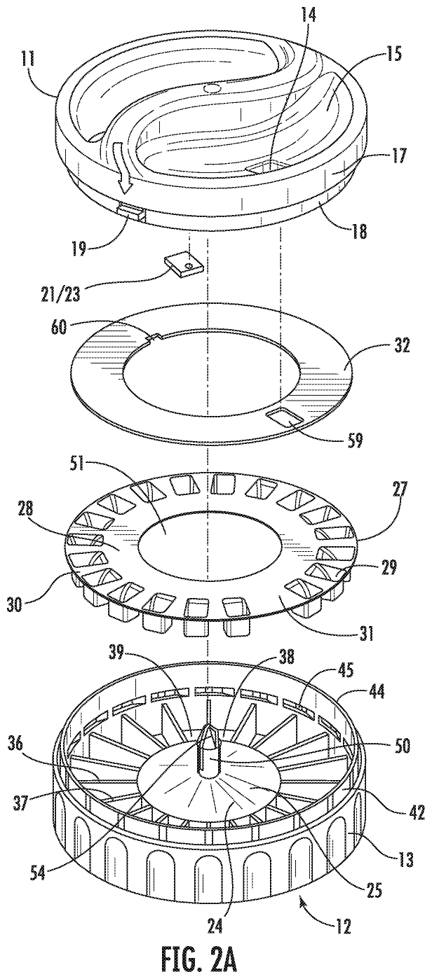

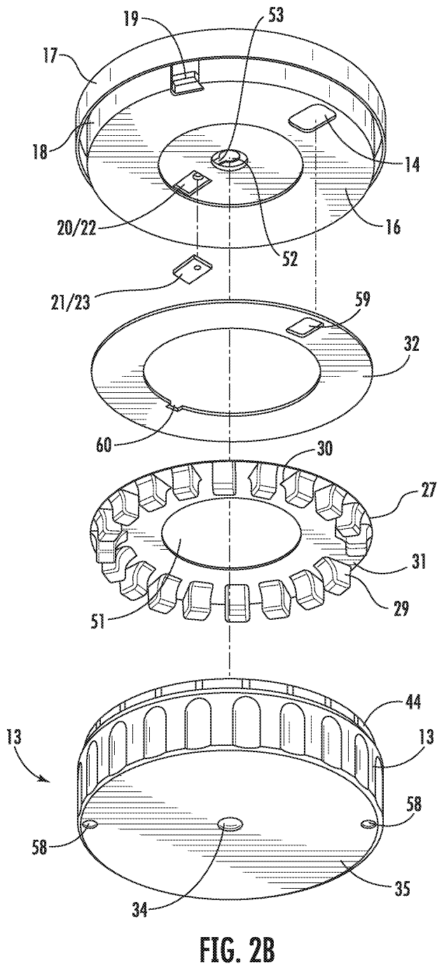

With reference to FIGS. 2A and 2B, indexing cover layer 11 can comprise a top or exterior facing surface 15, a bottom or inner facing surface 16 (best illustrated in FIG. 2B), a first side wall 17, and a second side wall 18 (best illustrated in FIG. 2B) about the exterior circumference of the indexing cover layer 11. In some embodiments, second side wall 18 is integral to first side wall 17, comprises a smaller diameter than first side wall 18, and is positioned below first side wall 17. In one embodiment, indexing cover layer 11 can comprise an indexing lock 19, which is important to safety and child proofing function described in more detail below. In some embodiments, indexing lock 19 is structurally integral to second side wall 18 of indexing cover layer 11 and protrudes outward toward the exterior of pill dispensing assembly 10. In some embodiments, indexing lock 19 is compressible or can be pushed inward. In another embodiment, two indexing locks 19 may be included 180 degrees offset such that the user depresses both indexing locks 19 while simultaneously using the dial 26 to rotate the indexing cover layer with the other hand to the next pill tray 27 (discussed below) position to deliver a pill external to the device.

With continued reference to FIG. 2A-2B, indexing cover layer 11 can comprise an exit port 14 as discussed above for pill dispensing to the outside environment. In some embodiments, the indexing cover layer 11 can further comprise a sensor housing 20, a sensor 21, a controller housing 22, and a controller 23. In some embodiments, the sensor 21 and controller 23 with the respective housings are positioned on the interior facing surface 16 of indexing cover layer 11. “Interior facing surface” is defined as the surface with the largest surface area that faces the interior space of a fully assembled pill dispensing assembly. Likewise, “exterior facing surface” is defined as a surface with the largest surface area that faces the exterior space of a fully assembled pill assembly. In one embodiment, the sensor 21 detects each indexed movement or rotation of the indexing cover layer 11 with respect to the container layer 12 by detecting each a detection element 24 of a detectable element array 25 (discussed in more detail below) coinciding with each indexed movement or single pill dispensed. The output of the sensor 21 is detected by the controller 23 which in turns captures a time stamp for indexed movement thus recording when each pill is dispensed. In one embodiment, sensor 21 is light based and located on or alongside controller 23, which can be mounted to or contained within a controller housing 22 in either the bottom surface of the indexing cover layer 11 or top surface of container layer 12.

In one embodiment, the indexing cover layer 11 can include a gripping member 26 which, in some embodiments, protrudes upward from exterior or top surface of indexing cover layer 11 forming a grip surface for the user. The gripping member 26 can act as a handle or dial for the user to rotate indexing cover layer 11 with respect to container layer 12 thereby exposing exit port 14 to the next position of a pill tray 27 (and the pill contained therein) positioned within container layer 12, so that the pill can be dispensed via the exit port 14. In an alternative embodiment, the user can grasp the first side surface 17 (shown in FIG. 2B) which omits the gripping member 26, to rotate the indexing cover layer 11 with respect to the container layer 12.

With continued reference to FIGS. 2A-2B, the container layer 12 can be configured to receive the pill tray 27. In some embodiments, the pill tray 27 can comprise a top surface 28 and pockets 29 with dividers or ribs 30 (explained more fully below) between and around the pockets 29 of the pill tray 27. In one embodiment, pill tray 27 is rotationally fixed in position within container layer 12. For example, pill tray 27 along with any incorporated elements can be keyed/configured such that it is fixed rotationally with respect to the container layer 11 and when the pill dispensing assembly is assembled, the pill tray 27 can be sandwiched between the indexing cover layer 11 and container layer 12. Pill tray 27 can further comprise a null position 31, which is a gap between pockets 29 and the position adjacent to exit port 14 upon immediate assembly of the device. In an alternative embodiment, the pockets 29 are an integral component of the container layer rendering the pill tray 27 unnecessary. For example, pockets 29 can be structurally incorporated into the radial ridge array.

In some embodiments, an outermost edge of pill tray 27 can comprise perforations about the perimeter of pill tray 27 such that the outermost edge can be manually detached from the main portion the pill tray 27 containing the pill pockets 29 either after the pills are loaded into the pockets 29 or after the pill dispensing assembly 10 is assembled. Removal of the outermost edge of pill tray 27 after it is no longer needed for the load operation can allow components of pill dispensing assembly to fit together more snugly.

In some embodiments, the pill dispensing assembly 10 can comprise a moisture proof seal or seal element 32. In one embodiment, the seal element is integral to the interior facing surface 16 of indexing cover layer 11 and comprises a substantially flat seal surface which engages and top surface 28 of pill tray 27 to create a moisture proof seal between pill tray 27 and bottom surface 16 of indexing cover layer 11. In another embodiment, the seal element 32 is affixed to the interior facing surface 16 of the indexing cover layer 11, for example, by gluing it to the surface. In another embodiment, such as the embodiment shown in FIG. 2, the seal element 32 may be a thin disc of material that forms a moisture proof seal in the area where the pill tray 27 is contained as it is sandwiched and may be slightly compressed between the indexing cover layer 11 and container layer 12. The seal element 32 may be keyed/configured such that it is fixed rotationally with respect to the indexing cover layer 32 and comprise a seal exit hole 59 that is fixed in alignment with the exit port 14 in the indexing cover layer 11. The seal element 32 can further comprise a seal keyway 60 or other structure to fix the seal element 32 rotationally with the indexing cover layer 11 via a mating surface configured in the indexing cover layer 11.

In another embodiment, pill dispensing assembly 10 can comprise a pocket cover 33 (not shown in the FIGS.). In some embodiments, the pocket cover 33 can comprise a thin segment of material that may be placed on top of a section of the container layer 12 or pill tray 27 to cover a desired number of pill pockets 29 prior to placing pills on top of the container layer 12 or pill tray 27 during the load operation described herein. The function of the pocket cover 33 is to prevent pills from entering one or more pill pocket positions when less than the full pill holding capacity of the pill dispensing assembly 10 is not needed and loading of adjacent consecutive pill pockets is desired. The pocket cover 33 can be configured with portions of material that extend downward into the pill pockets 29 toward the outer portion of the pill pockets 29 to restrict the size of the pill pockets 29 (pocket cover 29 is not shown in the Figures), thereby only allowing a single smaller pill to be loaded. Once the intended pills are loaded into the pill pockets 29, the pocket cover 33 may be removed to enable attachment of the container layer 12.

Referring to FIG. 2B, container layer 12 can include a spin bump 34 on a bottom surface 35 of container layer 12. In some embodiments, the spin bump 34 is a small downwardly protruding circular bump positioned in the center of bottom surface 33 of container layer 12. Spin bump 34 can facilitate rotation of the container layer 12 during a load operation described herein by reducing the friction between the container layer 12 and the surface such as pharmacy benchtop.

With continued reference to FIG. 2A, container layer 12 can include a radial ridge array 36 which can be a series of ridges or ribs 37 radially positioned on the lower (alternatively “inner”) surface 38 of the container layer 12 configured to extend radially forming slots or segments 39 between adjacent ribs 37 in the series. In some embodiments, a function of the radial ridge array 36 is to help channel or guide pills during the load operation into pockets 29 of pill tray 27. Moreover, pill tray 27 can be designed such that it rests on the edges of ribs 37 with pockets 29 of pill tray 27 resting within the slots 39 of radial ridge array 36.

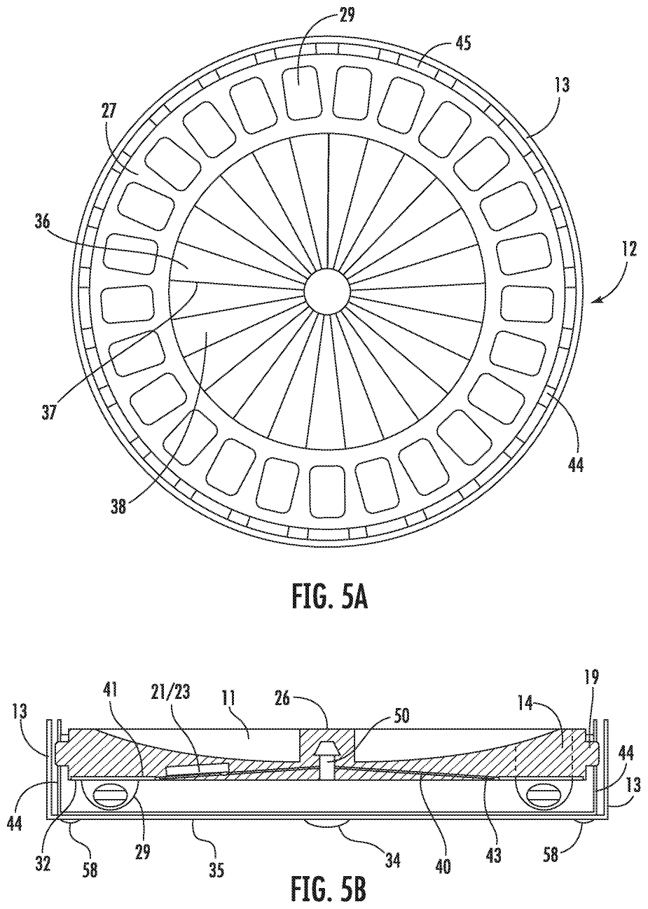

In other embodiments, the container layer 12 can include a ramp feature 40 as shown in FIG. 5B, which can be a radially projecting sloped surface on lower or inner surface 38 of the container layer 12. Ramp feature 40 facilitates travel of pills outward via centrifugal force and/or the slope of the ramp feature 40 alone during the load operation described in more detail below. In other words, the lower inner surface 38 of the container layer 12 can be ramped or sloped and the pill tray 27 and pockets 29 configured in a manner such that pills are biased outward and into the outer portion of pockets to minimize the necessary agitation required to load the pills into the pockets. Other surfaces can be configured to act as pill deflectors to facilitate distribution of pills to respective pockets during load operations. For example, the ribs 37 of radial ridge array 36 can deflect pills to facilitate rotary distribution of pills during the loading.

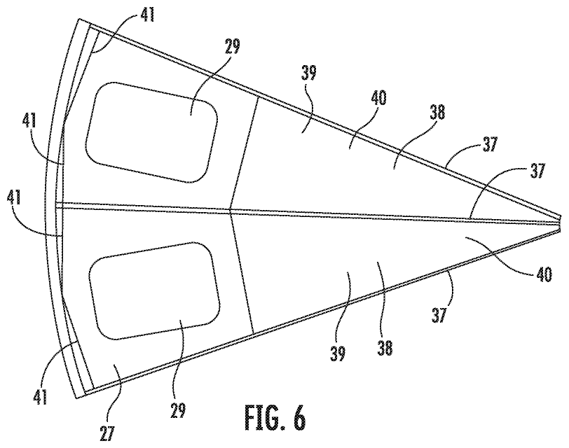

In the embodiment depicted in FIG. 6, container layer 12 can further comprise a one or more (plurality) deflector elements 41 which, in some embodiments, can be an undulating surface located on an inner surface of the outer vertical wall 42 of index slot array (described more fully below) of container layer 12. In one embodiment, the function of the deflector elements 41 is to interact with pills that have reached or in a region near the inner surface of outer vertical wall 42 of index slot array, but have yet to fall into a pocket 29 during the load operation described herein by deflecting the pills inward toward the center so that they are more effectively distributed to pockets. Deflector elements 41 may be arranged into an array and aligned with pockets 29 of pill tray 27 when engaged to container layer 12.

As shown in the embodiment illustrated in FIG. 5B, the container layer 12 can include anti-tampering barriers 43. The anti-tampering barrier(s) 43 are designed to obstruct access via the exit port 14, for example, in route to the sensor(s) 21 which, in one embodiment, is located opposite from the exit port 14. The anti-tampering barrier(s) 43 and other surfaces between the container layer 12 and indexing cover layer 11 form a barrier to objects that one might insert between layers with the aim of inappropriately manipulating the sensor(s) 21. Further, the sensor(s) 21 can be positioned far from the exit port 14 (e.g. 180 degrees offset and on the opposite side of the device such that the post element (described more fully below) provides further obstruction to tampering by eliminating direct linear access to the sensor(s) 21 from the exit port 14.

Referring to the embodiment shown in FIG. 2A, container layer 12 can include an index slot array 44 which can comprise a series of openings or indexing slots 45 positioned about the outer vertical wall 42—each slot 45 coinciding with each pocket 29 in the pill tray 27. The openings or indexing slots 45 can be oval or rectangular shaped as shown in FIG. 2A, or any configuration. For example, the slots 45 can be circular shaped or, in some embodiments, upwardly facing open channels or apertures with open top regions. The slots 45 of index slot array 44 interact with indexing lock 19 of indexing cover layer 11 to block rotation when indexing slot 45 and indexing lock 19 are engaged or permit rotation when slot and lock are disengaged. Upon rotation and alignment between indexing lock 19 and slot 45, indexing lock 19 recoils and reengages slot 45 to prevent further rotation. Alignment of indexing lock 19 with slot 45 coincides with alignment of the exit port 14 with the next position of the pill tray 27, thereby exposing the pill therein to the exit port 14 for delivery external to the pill dispensing assembly 10.

The function of index slot array 44 is for the individual slot 45 surfaces to interact with the surfaces of the indexing lock 19 (described below) to allow the indexing cover layer 11 to be rotated with respect to the container layer 12 when the respective blocking surfaces are disengaged thereby allowing rotational independent movement between indexing cover layer 11 and container layer 12 and index to and stop at the next position due to reestablishment of the blocking interaction of surfaces upon recoil of indexing lock 19 to rest position to coincide with alignment of the exit port 14 with the next position of the pill tray 27, thereby exposing the pill therein to the exit port 14 for delivery external to the pill dispensing assembly 10 one pill at a time. The exit port 14 may be a straight passage or may be configured to exit perpendicular to the vertical axis.

As illustrated in FIG. 2A-2B, container layer 12 can be configured with an outer compression wall 13 that can be pushed inward or pressed by the user to disengage one or more indexing locks 19, which may be configured in an inwardly flexible portion of the outer vertical surface of the indexing cover layer 11. In other embodiments, compression wall 13 can be omitted from the assembly altogether. In such design, a user directly presses the indexing lock 19 (or multiple indexing locks in some embodiment) to move the indexing lock 19 inward and clear of slot 38. In the embodiment utilizing the compression wall 13, the indexing lock 19 and indexing slot 38 is concealed by the compression wall; thereby avoiding user tampering. As best illustrated in the embodiment shown in FIG. 2A, there can be minor clearance between the vertical facing surfaces of the container layer 12 (e.g., outer wall 42) and the compression wall 13. Furthermore, the very top edge of compression wall 13 can be configured to fit inside the first side wall 17 of the indexing cover layer 11.

The indexing lock 19 can be configured such that it is slightly flexible and can be pushed inward toward the center of the container layer 11. Depressing the indexing lock 19 (or simultaneously multiple indexing locks in some embodiments), either via compression wall 13 or via direct contact with the user's fingers, will allow the container layer 11 to rotate with respect to the indexing cover layer 12 until the indexing lock 19 aligns with the next position in the index slot array 37 whereby the indexing lock 19 deflects back outward to its position of rest and engages the next position of the index slot array 37, thereby preventing further rotation in either direction. The indexing lock 19 may be configured such that it has a sloped surface that allows it to advance to the adjacent position of the index slot array 37 in one direction of travel when depressed and prevented from rotation in the opposite direction. The function of the indexing lock 19 is to interact with the index slot array 37 during the dispense operation described herein to index the exit port 14 to expose successive individual pockets 29 in the pill tray 27 thereby allowing pills to be dispensed external to the pill dispensing assembly 10 one at a time.

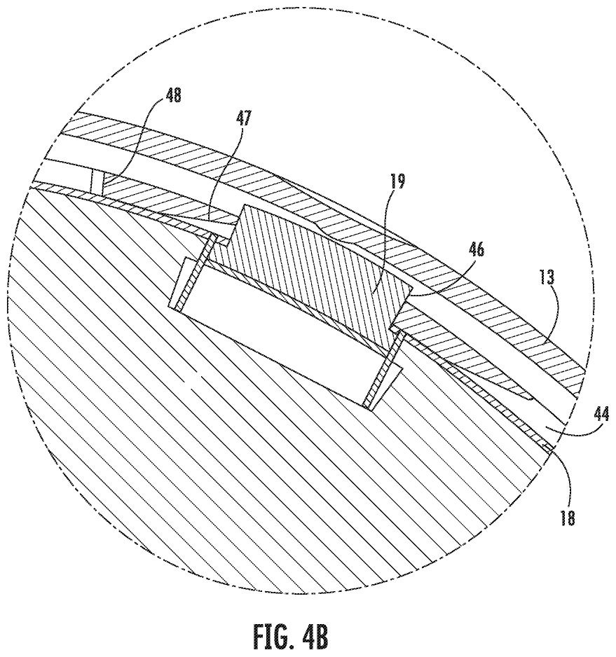

FIG. 4B illustrates a close-up cut away view of and embodiment of the indexing lock 19, index slot array 44 with compression wall 13, allowing one to visualize how the mechanism permits only single position rotation and prevents reverse rotation of indexing cover layer 11 with respect to the container layer 12. In one embodiment (shown in FIG. 4B), the leading edge 46 of the indexing lock 19 (e.g., during standard CW rotation) and the leading edge 47 of the slot 45 are sloped. In this embodiment, the sloped edges promote rotation as follows: a user compresses compression wall 13 until engagement with container layer 12 and thus also indexing lock 19 which is protruding through slot 45 causing indexing lock 19 to travel inward far enough for the leading edge 46 of the indexing lock 19 to engage slope of the leading edge 47 of the slot 45 thereby allowing indexing lock 19 to clear slot 45 and dial 26 to be rotated. At this point the lagging edge 47 of the indexing lock 19 does not clear the lagging edge 48 of the slot 45, thereby preventing reverse dial 26 rotation. As the dial 26 is rotated CW, the interaction of the leading ramp feature of the indexing lock 19 and slot 45 causes the indexing lock 19 to slightly deflect further inward. Once dial 26 is turned CW to the next pill position, the indexing lock 19 will spring back into the next index slot array 44 position and the exit port 14 will be aligned with the next pill which can be delivered external to the pill dispensing assembly 10 by inverting the assembly.

Other configurations of the indexing lock can be used to allow this indexing operation via inward manual depression to disengage blocking surfaces. By “blocking surfaces” it is intended to mean the surfaces of the indexing lock and the index slot which interact to prevent rotation when the indexing lock is at rest position (e.g., fully engaged with the slot). This functionality offers a child proof dispensing operation that only allows advancement to next pill pocket and dispensing one tablet at a time per single depression of a hidden indexing lock 19 through manipulation of the adjacent portion of the compression wall 13 as indicated by an arrow 49 molded into the indexing cover layer 11, in some embodiments. Compression wall 13 prevents the need to make direct contact with the indexing lock 19 and adds a further measure of security (e.g. child proof, accidental duplicate dispensing). The example indexing mechanism disclosed herein is only one example; multiple catches and dis-engageable catch retention surfaces between indexing cover layer 11 and container layer 12 are envisioned and intended.

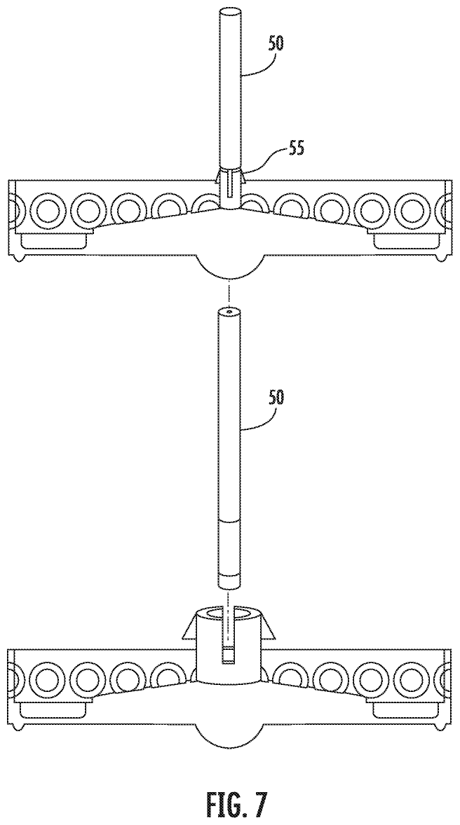

In the embodiment shown in FIGS. 2A, 5B, and 7 container layer 12 can contain a post element 50 located at or near and protruding up from the container layer 12, through opening 51 in pill tray 27 and through bottom surface 16 of the indexing cover layer 11 through aperture 52. Aperture 52 of the indexing cover layer 11 can comprise an internal ridge 53 formed by a portion of aperture 52 coinciding with position of the spring activated key element 54 when the container layer 12 and indexing cover layer 11 are assembled and where the internal diameter of the aperture 52 has a larger step change in diameter that allows a spring activated key element 54 on a tip of post element 50 to retract as post element 50 is inserted through aperture 52. Once key element 54 clears aperture 52, key element transitions back to fully open position through spring activation thereby securing post element 50 and thus container layer 12 to indexing cover layer 11 while preserving the ability for the indexing cover layer 11 to rotate with respect to the container layer. In some embodiments, the post element 50 can be used as a spin dial to invoke spinning actions described in the loading process below. In another embodiment, the post element 50 (as shown in FIG. 7) can be configured with a break point 55 at a position of desired breakage and detachment so that after all intended pills are contained with pockets of pill tray 27, the extended part of the post element 50 may be removed and disposed of as in FIG. 7. The same function served by the extended portion of the post element 50 may be served by a non-attached tool as shown in FIG. 7. The post element 50 and aperture 52 can be swapped between the indexing cover layer 11 and the container layer 12 to achieve the same function which is to assemble and hold the layers together in a final product such that the seal surface 31 incorporated in the bottom surface 16 of the indexing cover layer 11 properly mates with the top surface 28 of the pill tray 27 about and around the region of pockets 29 of the pill tray 27 to prevent moisture ingress.

As shown in FIG. 2A, indexing cover layer 11 can contain a knockout 56 on the outer perimeter of aperture 52. The function of the knockout 56 is to provide access to post element 36 in order to unlatch key element 54 so that the container layer 12 may be separated from the indexing cover layer 11 only after removal of the knockout 56. In some embodiments, connecting tabs on the knockout 56 must be broken in order to remove the knockout. Such features are helpful in the detection tampering and efforts to disassemble the pill dispensing assembly 10. The surface around the knockout 56 may be flat and with enough area to affix a prescription label or tamper proof label.

Controller 23 can incorporate electronic components including processor, memory, a sensor(s) 21, and an input/output (I/O) devices. The processor can receive pill detection information from the sensor(s) 21 and records either the raw data, or information related to the raw data. For example, the processor can simply record in memory the time that individual pills are progressed to the exit port 14. In another example, the processor can calculate and record in memory other information relating to pill dispensing, such as a time duration between subsequent pill dispenses, or next dose time.

The processor can be operatively connected to an I/O device, which can serve as an output device to transmit and receive recorded pill timing information and other pill dosing information to a multitude of remote receiver types. Throughout this application, the phrase “pill dosing information” can include one or more of the following: a dosing non-compliance indication, a pharmacy ID, a pharmacist ID, a patient ID, prescribed drug information, etc. For example, the I/O device can include a radio transponder for transmitting/receiving wireless radio frequency (RF) signals between a multitude of remote transceiver/transponder types (e.g. RFID reader, cell phone equipped with reader technology) to automatically download dosing data from the device to computer system. Thus, the I/O device interface, which can be demand or automatically invoked via application software on a computer system (e.g. PC, cell phone) to interface with the device firmware. Downloaded data on the computer system can be processed by application software and make available useful interpretations and representations of accumulated dose data (e.g. graphical history over multiple filled prescriptions) and/or to trigger various electronic communication (e.g. text, phone call, emails, device alert) which can be used by a stakeholder such as a patient, pharmacist or doctor to determine if a patient is exhibiting inappropriate dosing patterns (e.g. is the patient exceeding number of tablets per time period).

The transceiver described above can be part of a passive or active Radio Frequency Identification (RFID) chip, such as a Battery Assisted Passive (BAP) tag, for example. Thus, communication with the I/O device can be performed wirelessly (e.g. RFID) or via a hardwired connection to the output port, for example. The processor can encrypt the recorded pill timing information and/or the pill dosing information that is stored in memory. This encryption can be performed such that only an authorized party, such as a pharmacist computer system, would be able to decrypt the data.

The controller 23 can include software, hardware, or any combination thereof to implement these features, and those described below. The processor can include an Application Specific Integrated Circuit (ASIC), a Field Programmable Gate Array (FPGA), microprocessor/microcontroller, or any other type of processing circuit.

The processor can maintain an internal digital clock with date and time values. This internal clock could be initiated by a manufacturer of the pill dispensing assembly 10, or by a pill filling entity such as a pharmacy. Firmware executed by the processor could be used to monitor the electronic signal from the sensor(s) 21 via detection of detectable element array (iii) when the exit port 14 of the indexing cover layer 11 is indexed to the next pill pocket position in the pill tray 27 indicating that a tablet is dispensed and repeat that process for each table dispensed. These events would trigger the firmware to save a value associated with the times and date stamps of each dispense operation into internal memory. The electronic components of the controller 23 allow the contents of the memory to be downloaded for review in human readable form or for potential use by a wireless interfaced computer system (e.g. cell phone, pharmacy PC).

The processor can also be operatively connected to optional notification devices integrated into the device to provide a patient notification, such as the arrival of a dosage time, or a predefined amount of time passing after a suggested dosing time. The notification devices can include, for example, a vibrating transducer, LCD display, a light (e.g. a light emitting diode “LED”), or a sound-emitting device configured to provide a notification at a dosing time and other pertinent information.

The processor can also be operatively connected to an additional input device and a display. The additional input devices can include buttons on the device (switch closure inputs to controller) for example to allow the loader of tablets (e.g. a pharmacy) to store pill dosing schedule in the memory in a manual fashion or to manually trigger sync with cell phone for downloading data. The memory can also store encrypted and/or unencrypted personal information about a patient, including some of the pill dosing information discussed above (e.g. a photo identification number or another personal identifier, pharmacy ID, pharmacist ID, etc.).

A power source (e.g. a battery) can be used to power the controller 23, sensor 21 and any alert device, input device, and display as needed.

An optional display can be connected electronically to the controller 23 and mounted such that it is readable by the user external to the pill dispensing assembly 10 (e.g. incorporated either as part of the indexing cover layer 11 or container layer 12 and can be used to indicate dosing information to either a patient or caregiver (e.g. remaining time until next dose), or to a loader of tablets (e.g. an indicator of tampering or variance from the dosing schedule). For example, the display could display the time remaining until a subsequent dose and/or a time of a last dose display (LCD), for example. Thus, the display can also be used as a notification device as described above.

Detectable element array 35 can take the form of any detectable feature that any type of sensor can detect on any opposing layer a change based on positional alignment with one or more sensor(s) 21. In one embodiment, detectable element array 25 can be radially aligned alternating light and dark surfaces coinciding with individual positions of pill tray 27 and incorporated on the inner surface of the opposing internal surface of either the opposing indexing cover layer 11 or container layer 12. This allows the a “light sensing” sensor 21 to detect each transition of the dark and light surfaces noting each time the indexing cover layer 11 is indexed to the next position of the pill tray 27. Detection of this event allows the controller 23 to record the time each pill is dispensed. Other detection element arrays include optically distinguishable features such as a uniform barcode, and the like.

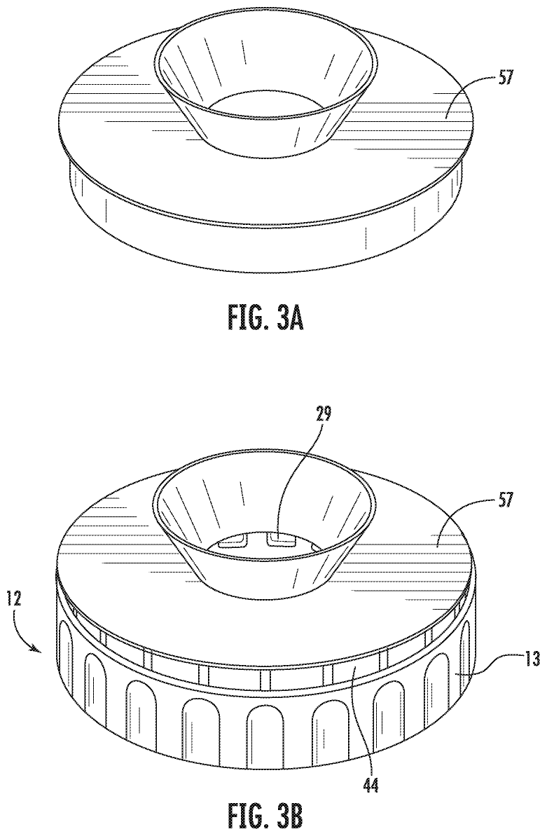

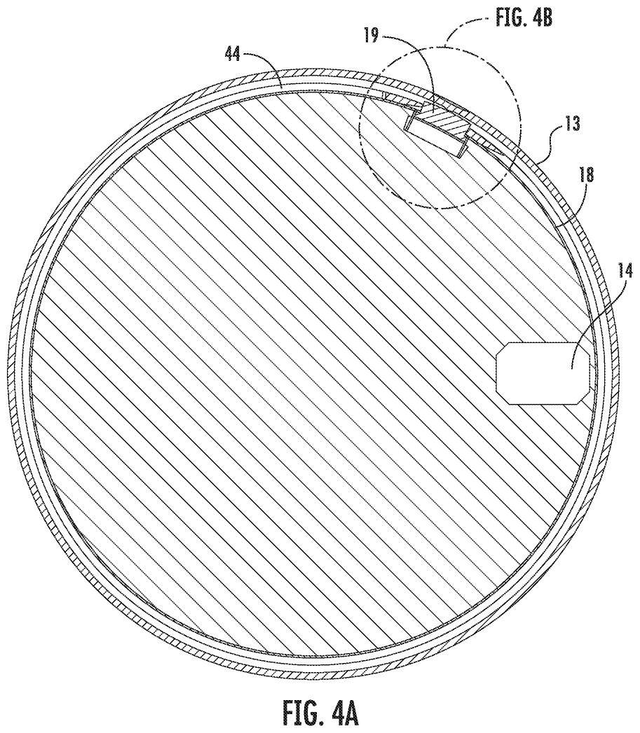

In one embodiment, to load the device, a pharmacist (or other user) can place the container layer 12 on a flat surface; select and insert an appropriate pill tray 27 depending on size and shape of pills for example; place an optional load funnel 57 (show in FIGS. 3A-3B) on top of the container layer 12 as depicted in FIG. 3B; dispense the pills into the pill tray 27 via funnel 57; grasp the top of the load funnel 57 between fingers and rotate back and forth CCW/CW to distribute pills to pockets in the pill tray 27. Optionally, the user can slightly lean the container layer 12 toward yet to be filled pockets to quickly fill the pockets in a somewhat similar fashion as a roulette wheel. The spin bump 34 located in the center of the bottom surface of the container layer 12 facilitates rotation and slight leaning of the container layer 12.

Container layer 12 can optionally include one or more balancing elements 58 which may be one or more regions substantially located on the outer region of the bottom surface of the container layer 12. The function of the balancing elements 58 is to control the extent that the container layer 12 may be allowed to tilt during the load operation described herein. The ability to optionally tilt the pill dispensing assembly 10 can be utilized to facilitate movement of pills to pockets 29 into pill tray 27 that have yet to be filled during the loading process described herein.

Where preferred, the pharmacist or user can use a pill counting tool or the like to distribute pills amongst the pockets. In continued operation, the pharmacist can then remove the optional load funnel 57; remove the battery insulator strip to boot up the controller if used; and insert the indexing cover layer 11 over the keyed post element 50 until it snaps in place to complete assembly of the device. When assembled the exit port 14 is located on the null position 31 which does not contain a pill pocket. The pharmacist can then scan the device to log a unique device identifier and associate it with the specific prescription/patient. In a refill situation, the patient can return the device, and upload dose level data to the external computer system unless upload is achieved via other computer systems and application (e.g. cell phone). Presentation/use of the dose level data to drive various task/communications is covered in prior sections at only a high level but could include data presentations/controls/communications in response to dose patterns recognized by configurable software application as indicative of bad as well as good dosing behaviors (e.g. diversion, pre-addiction pattern, proper tapering pattern).

In some embodiments, the bottom, inner, or interior facing surface 16 of indexing cover layer 11, which contacts top, inner, or interior facing surface 28 of pill tray 27 about the pockets, can be composed of a seal surface 58 material which can be formed via two stage injection molding process. Seal surface 58 serves to prevent moisture ingress to pills. The indexing cover layer 11 can comprise a depressible indexing lock 19 which is configured to be depressed inward, but in its at-rest position engages and protrudes through an index slot array 44. The indexing lock 19 and slots 45 are configured such that rotation of the indexing cover layer 11 via dial 26 is allowed in one direction. The compression wall 13 is configured to cover the index slot array 44 so there is no direct user access to the indexing lock 19. In one embodiment, to index the device, the user holds the device in one palm, presses inward on the compression wall 13 at the spot indicated by the arrow on dial 26 with a fingertip, which coincides with the location of the indexing lock 19, then while depressed, rotates the dial 26 clockwise with their other hand. Once the indexing lock 19 reaches and is aligned with the next slot 45 position, the indexing lock 19 will automatically recoil outward and lock to prevent further rotation of the indexing cover layer 11 in either direction. This indexing action makes the next pill available for dispensing through the exit port 14 into the hand of the user upon inversion of the device. During indexing, sensor 21 can detect the positional change in the detectable element array 35. This allows the device to detect when each tablet is dispensed and to trigger the firmware to store the corresponding timestamp in its memory. The log of timestamps can be read via interface through the transceiver by an external computer system (e.g. cell phone, PC)/application software. To protect patient information, timestamp and other data can be encrypted and only converted/made human readable via software key only known by specific application/user. Presentation/use of the dose level data via computer system to drive various task/communications is covered at a high level in prior sections.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A pill dispensing assembly comprising:
an indexing cover layer comprising an interior facing surface, an exterior facing surface, a first side wall, a second side wall, an exit port for dispensing said pill to a user, and an indexing lock;
a container layer comprising an interior facing surface, an exterior facing surface, a side wall, a plurality of pockets for holding pills during pill dispensing assembly use, and an index slot array comprising a plurality of slots and blocking surfaces between adjacent slots circumferentially and equally spaced about said side wall for indexing lock engagement;
a compression wall that surrounds said side wall of said container layer wherein said compression wall contacts and depresses said indexing lock when said indexing lock is engaged with a slot and when compression wall is properly manipulated by the user, while also preventing direct user contact with said indexing lock and said index slot array;
a controller and/or sensor,
a detectable element array for sensor detection; and
a post element;
wherein said engagement of said indexing lock with said blocking surfaces blocks contact between said compression wall and said indexing lock.

2. The pill dispensing assembly of claim 1, wherein said plurality of pockets for holding pills are contained on an interchangeable pill tray that is positioned on said container layer.

3. The pill dispensing assembly of claim 1, wherein said indexing lock comprises a depressible tab.

4. The pill dispensing assembly of claim 1, wherein said indexing lock is mounted to said second side wall of indexing cover layer.

5. The pill dispensing assembly of claim 1, wherein said interior facing surface of said container layer is sloped toward pockets of pill tray to guide pills to the pockets during loading operation.

6. The pill dispensing assembly of claim 1, wherein said indexing lock and/or said slots comprise sloped leading edges and blocking rear edges to promote unidirectional rotation of indexing cover layer in relation to container layer.

7. The pill dispensing assembly of claim 1, wherein said pill tray comprises a null position with no pocket.

8. The pill dispensing assembly of claim 1 further comprising a controller slot for housing said controller positioned on said interior facing surface of said indexing cover layer.

9. The pill dispensing assembly of claim 1 wherein said container layer further comprises a plurality of deflector elements positioned on an inner surface of said side wall for deflecting pills toward pockets in said pill tray during loading operation.

10. The pill dispensing assembly of claim 1 further comprising a post element comprising a first end and a second end and wherein said second end is affixed to said interior facing surface of said container layer and said first end is mechanically engaged to said indexing cover layer such that index cover layer's rotatability in relation to container layer is preserved.

11. The pill dispensing assembly of claim 1 wherein said indexing cover layer further comprises a gripping element for a user to grip and turn the indexing cover layer in relation to the container layer.

12. The pill dispensing assembly of claim 1 wherein said container layer further comprises a spin bump centrally positioned on the exterior facing surface of said container layer.

13. The pill dispensing assembly of claim 1 further comprising seal element that substantially prohibits the ingress of moisture and contamination of pills stored in said plurality of pockets.

14. The pill dispensing assembly of claim 1 wherein said container layer further comprises one or more anti-tampering barriers which substantially disrupt access routes to said sensor through exit port.

15. The pill dispensing assembly of claim 1 further comprising a funnel for loading pills into the pill tray during loading operation.

16. A pill dispensing assembly consisting of:
an indexing cover layer comprising an interior facing surface, an exterior facing surface, a first side wall, a second side wall, an exit port for dispensing said pill to a user, and an indexing lock;
a container layer comprising an interior facing surface, an exterior facing surface, a side wall, a plurality of pockets for holding pills during pill dispensing assembly use, and an index slot array comprising a plurality of slots and blocking surfaces between adjacent slots circumferentially and equally spaced about said side wall for indexing lock engagement; and
a compression wall that is integral to and surrounds said side wall of said container layer wherein said compression wall contacts and depresses said indexing lock when said indexing lock is engaged with a slot and when compression wall is properly manipulated by the user, while also preventing direct user contact with said indexing lock and said index slot array.

17. A method of loading, dispensing, and tracking the prescriptive use of pills with a pill dispensing assembly comprising:
providing an unassembled pill dispensing assembly comprising an indexing cover layer comprising a depressible indexing lock, a container layer comprising an index slot array with a plurality of circumferentially and equally spaced slots, a plurality of interchangeable pill trays comprising pill pockets, and a loading funnel;
placing said container layer on a flat surface;
placing the loading funnel upon said container layer,
pouring pills into said loading funnel and distributing said pills into said pockets; and
removing said loading funnel and attaching said indexing cover layer to said container layer to produce a fully assembled pill dispensing assembly.

18. The method of claim 17, further comprising the steps of:
depressing said depressible indexing lock and disengaging said indexing lock from a slot within the plurality of circumferentially and equally spaced slots;
rotating said indexing cover layer in relation to container layer until indexing lock engages the next slot in the plurality of circumferentially and equally spaced slots; and
inverting the pill dispensing assembly and dispense the pill from said exit port.

19. The method of claim 17, wherein said depressing step is performed by a compression wall surrounding the container layer.

20. The method of claim 17, further comprising the steps of:
taking a time stamp of the rotating step with a sensor when said sensor is aligned with and senses a single detectable element of a plurality of detectable elements in a detectable element array;
wherein each detectable element of said plurality of detectable elements corresponds to a pill pocket; and
recording and storing said time stamp in memory.
